(19) United States
(12) Patent Application Publication
(10) Pub. No.: US 2021/0228992 A1
(43) Pub. Date: Jul. 29, 2021

(54) LIFTING SYSTEM FOR ACCESSIBLE PLAYGROUNDS

(71) Applicant: Jeffrey Bryant Barber, Thurmont, MD (US)

(72) Inventor: Jeffrey Bryant Barber, Thurmont, MD (US)

(21) Appl. No.: 17/158,948

(22) Filed: Jan. 26, 2021

Related U.S. Application Data
(60) Provisional application No. 62/967,280, filed on Jan. 29, 2020.
(60) Provisional application No. 62/986,258, filed on Mar. 6, 2020.

(51) Int. Cl. A63G 31/02; B66F 11/04

(52) U.S. Cl. CPC A63G 31/02; A63B 2208/12; B66F 11/04

(57) ABSTRACT

The present teachings include techniques for lifting a user (e.g., a person having an injury or a physical disability) onto playground equipment. One such technique includes coupling a lifting device to playground equipment and positioning a user on a first platform of the lifting device. Sub-platforms of the lifting device may be disposed between the first platform and an elevated engagement area of the playground equipment, where the sub-platforms define stairs between the first platform and the engagement area. An actuator may move the first platform upward toward the engagement area along a z-axis, and, either via the actuator or movement of the first platform, each of the plurality of sub-platforms may also move along the z-axis to form a substantially planar pathway between the first platform and the playground equipment at the elevated height.

### CROSS-REFERENCE TO RELATED APPLICATIONS

This application claims priority to U.S. Provisional Patent Application No. 62/967,280 filed on Jan. 29, 2020 and U.S. Provisional Patent Application No. 62/986,258 filed on Mar. 6, 2020, where the entire contents of each of the foregoing applications is incorporated by reference.

### FIELD

The present disclosure generally relates to devices, systems, and methods for accessible playgrounds, e.g., devices, systems, and methods related to lifting a user (e.g., a person having an injury or a physical disability or other limitation) onto playground equipment.

### BACKGROUND

A playground, playpark, or play area may generally include equipment and structures specifically designed for children (and others) to play thereon or therein. For example, modern playgrounds often include recreational equipment such as playhouses, rope play equipment, play sculptures, towers, bridges, catwalks, tunnels, ladders, seesaws, merry-go-rounds, swings, slides, jungle gyms, chin-up bars, sandboxes, spring riders, trapeze rings, mazes, climbers, spinners, and the like, many of which can help children develop physical coordination, strength, and flexibility, as well as help to provide recreation and enjoyment, and support social and emotional development. Playgrounds and playground equipment typically can be found in parks, schools, childcare facilities, institutions, multiple family dwellings, private properties and residences (e.g., a backyard), restaurants, resorts, recreational developments, stadiums, and other areas of public or private use. Commonly found in modem playgrounds are play structures that link many different pieces of playground equipment together to form a desired, modular playground.

While providing many benefits to those capable of using them, playgrounds often lack features that allow them to be used by a person with a disability, such as a person who uses a wheelchair or the like. Some efforts at inclusive and accessible playgrounds that can accommodate wheelchair users (and others having disabilities such as physical, mental, and/or emotional disabilities) include a ramp (or similar) placed at ground level. However, because such a ramp may require a relatively gradual incline for safety (e.g., an incline of only about 4 to about 5 degrees), these ramps can be cumbersome, often requiring a long cumulative ramp length to reach an elevated platform of a playground (where a common height of an elevated platform of a playground may be about 48-inches (121.92 centimeters) above grade). There thus remains a need for improved devices, systems, and methods for accessible playgrounds.

### SUMMARY

The present teachings include techniques for lifting a user (e.g., a person having an injury or a physical disability) onto playground equipment. One such technique includes coupling a lifting device to playground equipment and positioning a user on a first platform of the lifting device. Sub-platforms of the lifting device may be disposed between the first platform and an elevated engagement area of the playground equipment, where the sub-platforms define stairs between the first platform and the engagement area. An actuator may move the first platform upward toward the engagement area along a z-axis, and, either via the actuator or movement of the first platform, each of the plurality of sub-platforms may also move along the z-axis to form a substantially planar pathway between the first platform and the playground equipment at the elevated height.

In one aspect, a device for lifting a person onto playground equipment to provide accessibility for users with disabilities may include: a first platform accessible to a wheelchair via an entranceway, the first platform movable along a z-axis between a first position at a first z-axis height and a second position at a second z-axis height; one or more barriers adjacent to the first platform, the one or more barriers structurally configured to prevent the wheelchair from exiting the first platform at least along a first direction intersecting the z-axis; a second platform coupled to playground equipment and disposed away from the first platform along one or more of an x-axis and a y-axis, the second platform disposed at the second z-axis height; and a plurality of sub-platforms disposed between the first platform and the second platform, where, when the first platform is disposed in the first position, the plurality of sub-platforms define stairs between the first z-axis height of the first platform and the second z-axis height of the second platform, and where each of the plurality of sub-platforms is movable along the z-axis between a stair position and a platform position, the platform position substantially disposed at the second z-axis height. The device may also include an actuator engaged with the first platform, the actuator activatable to move the first platform along the z-axis between the first position and the second position; and one or more couplers connecting the first platform and one or more sub-platforms of the plurality of sub-platforms such that movement of the first platform via the actuator between the first position and the second position provides coordinated movement of each of the plurality of sub-platforms between the stair position and the platform position. In this manner, when the first platform is in the second position and each of the plurality of sub-platforms is in the platform position, a pathway may be formed between the first platform and the playground equipment, the pathway being substantially planar.

Implementations may include one or more of the following features. No gaps larger than ⅝-inches (1.5875 centimeters) may be present between the first platform and the plurality of sub-platforms, and no gaps larger than ⅝-inches (1.5875 centimeters) may be present between any of the plurality of sub-platforms. The device may further include risers coupled to each of the plurality of sub-platforms to minimize pinching, crushing, and shearing points. The pathway may lack voids larger than ⅝-inches (1.5875 centimeters) between structures defining the pathway. The stairs defined by the plurality of sub-platforms in the first position may be substantially aligned along a common axis. The stairs defined by the plurality of sub-platforms in the first position may not be substantially aligned along a common axis. The stairs defined by the plurality of sub-platforms in the first position may define a staircase including one or more turns. The stairs defined by the plurality of sub-platforms in the first position may at least partially define a spiral staircase. Each of the stairs defined by the plurality of sub-platforms in the first position may be disposed at an angle relative to one another along one or more of the x-axis and the y-axis. At least one sub-platform of the plurality of sub-platforms may be substantially rectangular. At least one sub-platform of the plurality of sub-platforms may be substantially triangular. Each of the plurality of sub-platforms may be at least 8-inches (20.32 centimeters) in depth. Each of the plurality of sub-platforms may be at least 48-inches (121.92 centimeters) in width. The device may further include a motor coupled to the actuator. The device may further include a hydraulic pump coupled to the actuator. The device may further include a power source coupled to the actuator. The power source may include photovoltaics for conversion of light into electricity. The power source may include a battery. The power source may include a connection to an electrical grid. The power source may include a manual crank. The actuator may include one or more hydraulic lifts. The one or more hydraulic lifts may include two hydraulic rams that move in coordination with one another. The one or more hydraulic lifts may be tethered to a pulley system connected to the first platform for moving the first platform. The actuator may be hydraulic, where the actuator does not require power to lower the first platform from the second position to the first position and each of the plurality of sub-platforms from the platform position to the stair position. A release of hydraulic fluid may trigger movement of the first platform from the second position to the first position and each of the plurality of sub-platforms from the platform position to the stair position. The release of hydraulic fluid may be controlled via one or more flow control devices. The actuator may be further engaged with one or more sub-platforms of the plurality of sub-platforms. The coordinated movement of each of the plurality of sub-platforms between the stair position and the platform position may include each of the plurality of sub-platforms moving in sequence between the stair position and the platform position. The sequence of movement may be overlapping. The first platform, the one or more barriers, the second platform, the plurality of sub-platforms, and the actuator may be contained in movable structure. The first platform, the one or more barriers, the second platform, the plurality of sub-platforms, and the actuator may be coupled together to form the movable structure. The one or more barriers may include a side barrier. The side barrier may extend from a side of the first platform. The one or more barriers may include two side barriers. The side barrier may include a wall. The side barrier may include a railing. The railing may be movable with one or more of the sub-platforms between the stair position where the railing functions as a banister and the platform position where the railing functions as a handrail disposed above the pathway. The railing may include a joint structurally configured to permit movement of the railing. The one or more barriers may include a protrusion disposed at the entranceway to the first platform. The protrusion may be sized and shaped to allow the wheelchair to roll over the protrusion when a predetermined amount of force is exerted on the wheelchair toward the entranceway. The protrusion may be movable between a blocking position and an unblocking position, the blocking position preventing the wheelchair from rolling over the protrusion, and the unblocking position allowing the wheelchair to roll over the protrusion. The one or more barriers may include a movable arm. The movable arm may be disposed at the entranceway to the first platform. The movable arm may be lockable in a position configured to prevent access to or from the first platform. The movable arm may automatically lock when the first platform is not in the first position. The movable arm may be a gate that is movable between an open position and a closed position. The device may further include a gate sensor structurally configured to detect when the gate is in the closed position. The gate sensor may be in communication with the actuator such that the actuator cannot lift the first platform unless the gate is in the closed position. The device may further include a platform engagement portion disposed on the gate and a gate engagement portion disposed on the first platform, the platform engagement portion and the gate engagement portion couplable with one another during movement of the first platform. Coupling of the platform engagement portion and the gate engagement portion during movement of the first platform may mechanically lock the gate in the closed position. The device may further include a ramp coupled to the entranceway leading to the first platform. The first platform may be at least 42-inches (106.68 centimeters) by at least 42-inches (106.68 centimeters) in size. One or more of the first platform, the second platform, at least one of the plurality of sub-platforms, and a portion of the playground equipment may be at least 60-inches (152.4 centimeters) in diameter. The second platform may define a smaller area than the first platform. The second platform may define a top step in the stairs defined by the plurality of sub-platforms in the first position. The second z-axis height may be at least 36-inches (91.44 centimeters) above the first z-axis height. A first coupler of the one or more couplers may connect the first platform and a first sub-platform of the plurality of sub-platforms, and a second coupler of the one or more couplers may connect the first sub-platform to another sub-platform of the plurality of sub-platforms. A different coupler of the one or more couplers may connect each sub-platform of the plurality of sub-platforms. The same coupler of the one or more couplers may connect each sub-platform of the plurality of sub-platforms. The device may further include one or more guides disposed adjacent to at least one sub-platform of the plurality of sub-platforms, the one or more guides facilitating predetermined movement of the at least one sub-platform between the stair position and the platform position and preventing other movement of the at least one sub-platform when moving between the stair position and the platform position. The predetermined movement may be substantially along the z-axis. The one or more guides may include one or more of a track and a rail. The one or more guides may include a protrusion engaged with at least one sub-platform of the plurality of sub-platforms, the protrusion structurally configured to cooperate with one or more of the track and the rail. The one or more guides may include at least one of a wheel, a bearing, a slider, and a glide. The device may further include one or more guides disposed adjacent to the first platform, the one or more guides facilitating predetermined movement of the first platform between the first position and the second position and preventing other movement of the first platform when moving between the first position and the second position. The predetermined movement may be substantially along the z-axis. The one or more guides may include one or more of a track and a rail. The device may further include one or more stops disposed below at least one sub-platform of the plurality of sub-platforms, the one or more stops positioned to prevent z-axis movement below the stair position for the at least one sub-platform. The one or more stops may include a stop for each sub-platform of the plurality of sub-platforms. The one or more stops may include at least two stops for each sub-platform of the plurality of sub-platforms, the at least two stops disposed on opposite sides of each sub-platform of the plurality of sub-platforms. The device may further include one or more walls disposed adjacent to the plurality of sub-platforms, the one or more walls structurally configured to prevent access by certain users to areas disposed beneath the plurality of sub-platforms. The one or more walls may be devoid of gaps larger than ⅝-inches (1.5875 centimeters). The device may further include a first switch structurally configured to activate the actuator for moving the first platform. The first switch may be disposed on or adjacent to the first platform. The device may further include a second switch structurally configured to activate the actuator for moving the first platform, the second switch disposed in a different location than the first switch. The second switch may be located on the playground equipment. The second switch may be accessible external to the device. The device may further include a platform sensor disposed on one or more of the sub-platforms, the platform sensor structurally configured to detect a presence of an object disposed on one or more of the sub-platforms. The platform sensor may be in communication with the actuator such that the actuator cannot be activated when the presence of the object is detected. The device may further include a pinch preventer disposed between one or more portions of the device having a gap. The pinch preventer may include a flexible material. The pinch preventer may be a rubber strip of material.

In one aspect, a system for accessible playground equipment may include playground equipment including an engagement area having a substantially planar surface disposed at an elevated height above grade, and a lifting device structurally configured for engagement with the engagement area of the playground equipment. The lifting device may include: a first platform movable along a z-axis between a first position at a first z-axis height and a second position at a second z-axis height, the second z-axis height substantially equal to the elevated height of the substantially planar surface of the engagement area; a plurality of sub-platforms disposed between the first platform and the substantially planar surface of the engagement area, where, when the first platform is disposed in the first position, the plurality of sub-platforms define stairs to traverse between the first z-axis height of the first platform and the second z-axis height of the substantially planar surface of the engagement area, and where each of the plurality of sub-platforms is movable along the z-axis between a stair position and a platform position, the platform position substantially disposed at the second z-axis height; an actuator engaged with the first platform, the actuator activatable to move the first platform along the z-axis between the first position and the second position; and one or more couplers connecting the first platform and one or more sub-platforms of the plurality of sub-platforms such that movement of the first platform via the actuator between the first position and the second position provides coordinated movement of each of the plurality of sub-platforms between the stair position and the platform position. When the first platform is in the second position and each of the plurality of sub-platforms is in the platform position, a pathway may be formed between the first platform and the engagement area of the playground equipment, where the pathway is substantially planar.

In another aspect, a method for providing accessibility to playground equipment for users with disabilities may include: coupling a lifting device to an engagement area of playground equipment; positioning a user on a first platform of the lifting device disposed at a first z-axis height, the first platform disposed adjacent to a plurality of sub-platforms, where the plurality of sub-platforms are disposed between the first platform and the engagement area of the playground equipment, the engagement area having a substantially planar surface disposed at a second z-axis height greater than the first z-axis height, the plurality of sub-platforms defining stairs between the first z-axis height of the first platform and the second z-axis height of the substantially planar surface; moving, via an actuator, the first platform along a z-axis from the first z-axis height to the second z-axis height; and moving, via one or more of the actuator and movement of the first platform, each of the plurality of sub-platforms along the z-axis from a stair position to the second z-axis height thereby forming a substantially planar pathway at the second z-axis height between the first platform and the playground equipment.

These and other features, aspects, and advantages of the present teachings will become better understood with reference to the following description, examples, and appended claims.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 illustrates a system for accessible playground equipment, in accordance with a representative embodiment.

FIG. 2 illustrates a front perspective view of a system for accessible playground equipment, in accordance with a representative embodiment.

FIG. 3 illustrates a rear perspective view of a system for accessible playground equipment, in accordance with a representative embodiment.

FIG. 4 illustrates a front view of a system for accessible playground equipment, in accordance with a representative embodiment.

FIG. 5 illustrates a railing of a device for lifting a person onto playground equipment when the device is in a stair position, in accordance with a representative embodiment.

FIG. 6 illustrates a railing of a device for lifting a person onto playground equipment when the device is in a platform position, in accordance with a representative embodiment.

FIG. 7 illustrates a device coupled to playground equipment when the device is in a platform position, in accordance with a representative embodiment.

FIG. 8 illustrates a gate of a device for lifting a person onto playground equipment, in accordance with a representative embodiment.

FIG. 9 illustrates a gate engagement portion of a first platform of a device for lifting a person onto playground equipment, in accordance with a representative embodiment.

FIG. 10 illustrates a platform engagement portion engaged with a gate engagement portion of a device for lifting a person onto playground equipment, in accordance with a representative embodiment.

FIG. 11 illustrates rollers and guides of a device for lifting a person onto playground equipment, in accordance with a representative embodiment.

FIG. 12 illustrates a device for lifting a person onto playground equipment, in accordance with a representative embodiment.

FIG. 13 illustrates a device for lifting a person onto playground equipment, where the device is transitioning from a stair position to a platform position, in accordance with a representative embodiment.

FIG. 14 is a flow chart of a method for providing accessibility to playground equipment for users with disabilities, in accordance with a representative embodiment.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “about,” “approximately,” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

In general, the devices, systems, and methods disclosed herein generally relate to providing accessible playgrounds. More particularly, devices, systems, and methods disclosed herein may relate to lifting a user (e.g., a person having an injury, a physical disability, or the like) onto playground equipment, which may include platforms and other structures that are elevated above the ground such that they are otherwise inaccessible to such users. Specifically, the present teachings may include a device structurally configured for coupling with playground equipment (e.g., new or existing playground equipment, which may be standard or custom made), and more particularly a device structurally configured for coupling with an elevated portion (e.g., an elevated platform) of the playground equipment. To this end, the device may include a platform and stairs that are movable to form an elevated pathway at substantially the same height as an elevated portion of playground equipment, where this pathway is capable of allowing a user having a disability (e.g., a user in a wheelchair) to access the elevated portion of the playground equipment, thus providing an accessible playground for the user.

In this manner, the present teachings may be specifically tailored for use with playground equipment, where implementations are capable of meeting known and future industry and government standards, e.g., safety standards. For example, implementations may be devoid of, or may otherwise minimize inclusion of, pinching, crushing, and/or shearing points. Also, or instead, implementations may include safety features specifically designed for use with children and users having disabilities. For example, implementations may include locking features for moving parts and the like, e.g., so that moving components can only function when it is safe to do so (e.g., when users are secured on, or clear of, moving components). Moreover, implementations may include barriers and guards around or near components for the safety of its users.

The present teachings may be used as a replacement for, or a supplement to, a transfer station on a playground, where such a transfer station typically includes relatively low and closely-separated platforms for users having disabilities to pull themselves onto, and a transfer station typically cannot accommodate a wheelchair. However, unlike a transfer station, the present teachings may lift a user having disabilities (with or without a wheelchair) into a position for accessing an elevated platform of playground equipment without the user needing to pull themselves up. In this manner, the present teachings may represent a vast improvement over a transfer station.

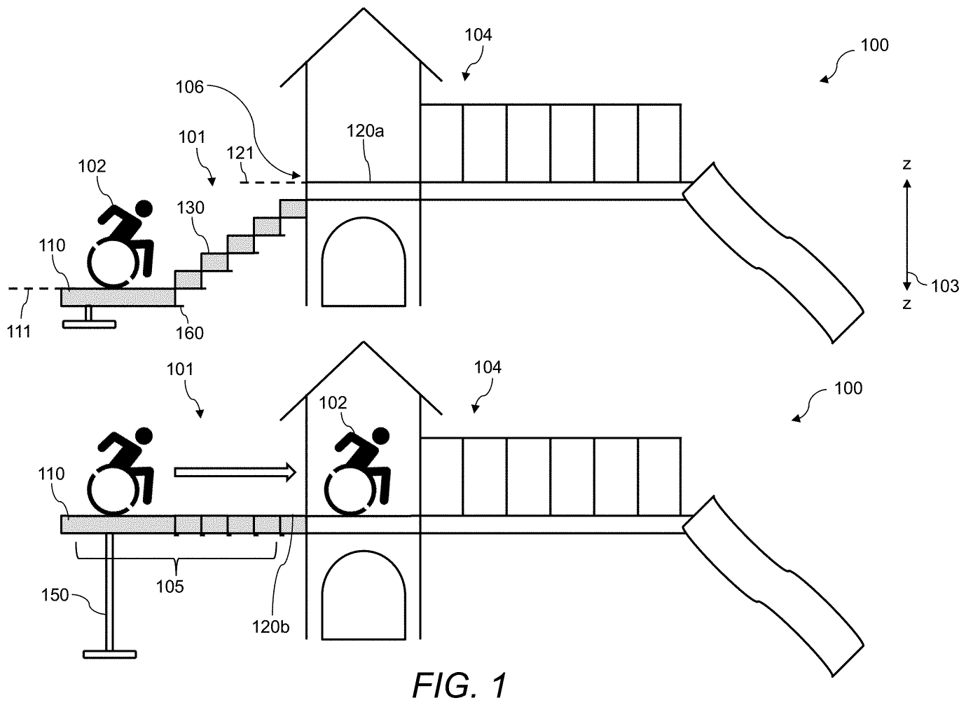

FIG. 1 illustrates a system for accessible playground equipment, in accordance with a representative embodiment. In particular, the figure shows a system 100 for accessible playground equipment featuring a device 101 according to the present teachings, where the device 101 is shown in a stair position (i.e., at the top of the figure) and a platform position (i.e., at the bottom of the figure). In particular, the figure shows a user 102 on a first platform 110 of a device 101 for lifting that is coupled to playground equipment 104, again where the device 101 is in the stair position toward the top of the figure and where the device 101 is in the platform position toward the bottom of the figure. As shown toward the bottom of the figure, in the platform position, a pathway 105 may be formed between the first platform 110 and the playground equipment 104 thereby allowing the user 102 to traverse from the device 101 to the playground equipment 104 along the pathway 105.

In particular, the system 100 for accessible playground equipment may include playground equipment 104 including an engagement area 106. The engagement area 106 may have a leading edge and a substantially planar surface disposed at an elevated height above grade, and a lifting device 101 structurally configured for engagement with the engagement area 106 of the playground equipment 104.

The lifting device 101 may be the same or similar to any of those as described herein, e.g., in the figures that follow. In general, the device 101 may be structurally configured for lifting a person onto playground equipment 104 to provide accessibility for users with disabilities. In this manner, the lifting device 101 may include a first platform 110 movable along a z-axis 103 between a first position at a first z-axis height 111 (as shown toward the top of the figure) and a second position at a second z-axis height 121 (as shown toward the bottom of the figure), where the second z-axis height 121 is substantially equal to the elevated height of the engagement area 106 (and/or a leading edge and/or substantially planar surface thereof), and where the substantially planar surface of the engagement area 106 may be defined by a second platform 120a. As described herein, in certain aspects, a second platform 120b may instead be part of the lifting device 101 (e.g., a top step thereof, portion of a frame, or other structure), and in other aspects, the second platform 120a may be part of the playground equipment 104. The lifting device 101 may further include a plurality of sub-platforms 130 disposed between the first platform 110 and the engagement area 106. When the first platform 110 is disposed in the first position, the plurality of sub-platforms 130 may define stairs to traverse between the first z-axis height 111 of the first platform 110 and the second z-axis height 121 of the engagement area 106. And, in certain aspects, each of the plurality of sub-platforms 130 may be movable along the z-axis 103 between a stair position and a platform position, where the platform position is substantially disposed at the second z-axis height 121.

The lifting device 101 may further include an actuator 150 engaged with the first platform 110, where the actuator 150 is activatable to move the first platform 110 along the z-axis 103 between the first position and the second position, and one or more couplers 160 connecting the first platform 110 and one or more sub-platforms 130 of the plurality of sub-platforms 130 such that movement of the first platform 110 via the actuator 150 between the first position and the second position provides coordinated movement of each of the plurality of sub-platforms 130 between the stair position and the platform position. When the first platform 110 is in the second position and each of the plurality of sub-platforms 130 is in the platform position, the pathway 105 may be formed between the first platform 110 and the engagement area 106 of the playground equipment 104. This pathway 105 may be substantially planar as shown in the figure.

As discussed herein, the device 101 may include one or more couplers 160. A coupler 160 may aid in facilitating coordinated movement of one or more of the first platform 110, the sub-platforms 130, and the second platform 120b. For example, the device 101 may include one or more couplers 160 connecting the first platform 110 and one or more sub-platforms 130 such that movement of the first platform 110 via the actuator 150 between the first position and the second position provides coordinated movement of one or more of the sub-platforms 130 (e.g., each of the plurality of sub-platforms 130) between the stair position and the platform position. By way of example, a first coupler may connect the first platform 110 and a first sub-platform of the plurality of sub-platforms 130, where a second coupler connects the first sub-platform to another sub-platform of the plurality of sub-platforms 130. That is, in certain implementations, a different coupler 160 may connect each sub-platform 130 of the plurality of sub-platforms 130. In other implementations, the same coupler 160 may connect each sub-platform 130 of the plurality of sub-platforms 130.

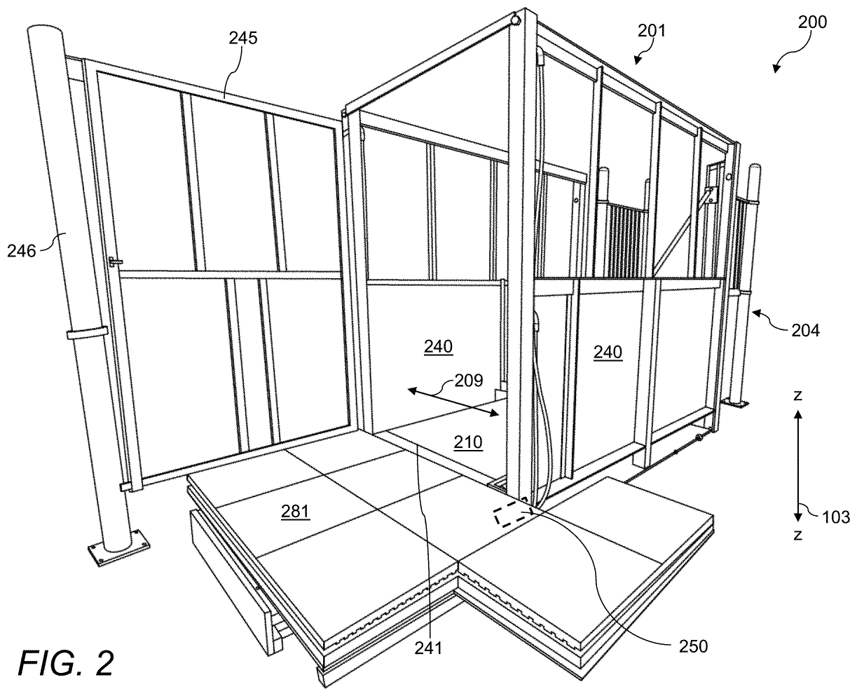

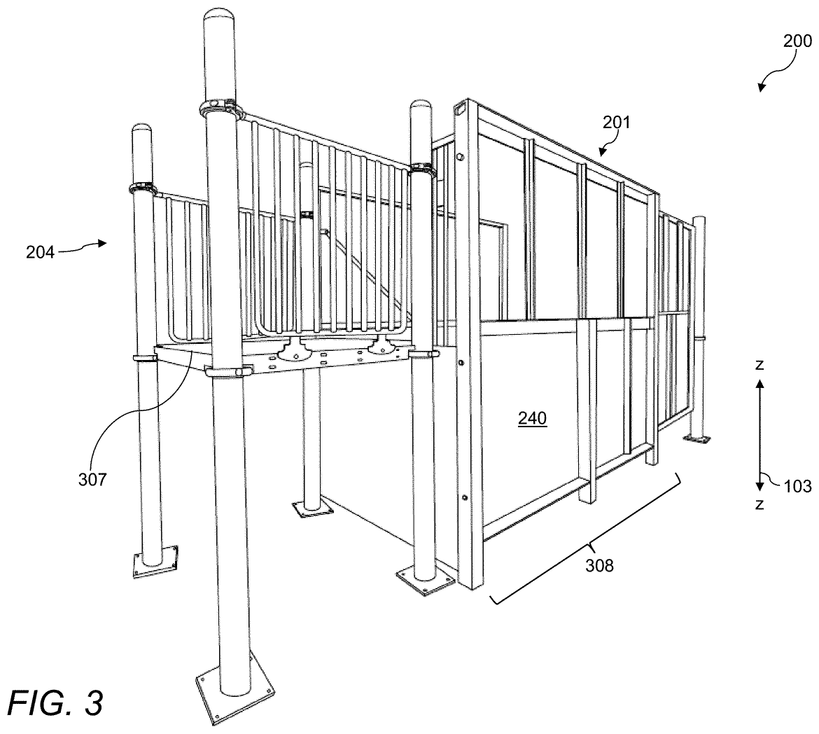

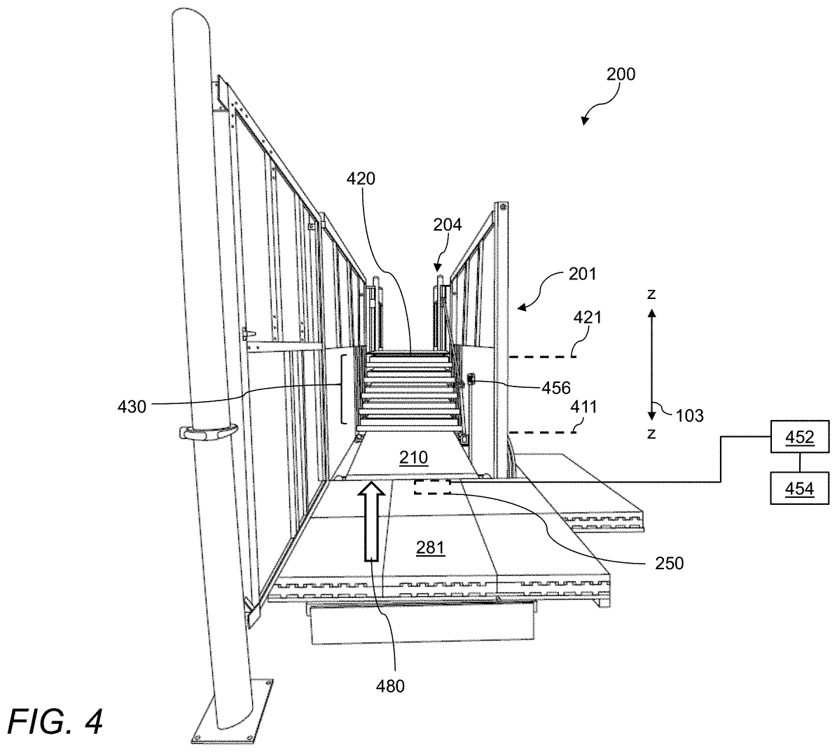

FIGS. 2-4 show different views of a system 200 for accessible playground equipment, where FIG. 2 illustrates a front perspective view of the system 200, FIG. 3 illustrates a rear perspective view of the system 200, and FIG. 4 illustrates a front view of the system 200. In general, the system 200 may include a device 201 for lifting a person onto playground equipment 204. In particular, the device 201 may be structurally configured for lifting a user onto playground equipment 204 (e.g., an elevated platform 307 thereof) to provide accessibility for users with disabilities, e.g., users having a physical disability such as a person that utilizes a wheelchair. In general, the device 201 may include a first platform 210, a second platform 420, a plurality of sub-platforms 430, one or more couplers connecting components of the device 201 (see, e.g., the couplers 160 in FIG. 1 described above), one or more barriers 240 for the protection and safety of users, and an actuator 250 for moving one or more of the components of the device 201 such as the platforms (e.g., one or more of the first platform 210 and the second platform 420) and the sub-platforms 430.

The first platform 210 may be sized, shaped, or otherwise structurally configured to be accessible to a wheelchair via an entranceway, an example of which is depicted by the arrow 480 in FIG. 4. The first platform 210 may be movable along a z-axis 103 between a first position at a first z-axis height 411 and a second position at a second z-axis height 421. It will be understood that the first position will generally correspond to a lowered position of the first platform 210 and may thus also correspond and be referred to herein as a “stair position” for the device 201, and that the second position will generally correspond to a raised position of the first platform 210 and may thus also correspond and be referred to herein as a “platform position” for the device 201. In certain implementations, the second z-axis height 421 is at least 36-inches (91.44 centimeters) above the first z-axis height 411. In other implementations, the second z-axis height 421 is at least 48-inches (121.92 centimeters) above the first z-axis height 411. Other heights are also or instead possible.

As explained herein, when the first platform 210 is disposed in the first position, the plurality of sub-platforms 430 may define stairs between the first z-axis height 411 of the first platform 410 and the second z-axis height 421 of the second platform 420, where the sub-platforms 430 are generally movable along the z-axis 103 between a stair position and a platform position that is substantially disposed at the second z-axis height 421. As further explained herein, when the first platform 210 is in the second position and each of the plurality of sub-platforms 230 are in the platform position, a pathway may be formed between the first platform 210 and the second platform 420, where the pathway may be substantially planar. In this manner, if the second platform 420 is coupled to, aligned with, or integral with an elevated portion of playground equipment 204 (e.g., an elevated platform 307), the pathway may allow a user to traverse along the pathway between the first platform 210 and the playground equipment 204, e.g., while using a wheelchair or the like.

In some implementations, the first platform 210 may be at least 42-inches (106.68 centimeters) by at least 42-inches (106.68 centimeters) in size, or the first platform 210 may otherwise have a diameter of about 42-inches (106.68 centimeters) or greater. More generally, the first platform 210 may be sized, shaped, and structurally configured to contain a user on a top surface thereof, such as a person utilizing a wheelchair or the like. This may include having a ramp 281 (or other platform or structure) coupled to, or otherwise defining, an entranceway leading to the first platform 210. In certain implementations, the first platform 210 may instead be disposed at grade level, e.g., by installing at least a portion of the device 201 or the first platform 210 in an excavated area, and/or by building up the ground level to meet the entranceway to the first platform 210.

The first platform 210 may also or instead be sized and shaped to provide clearance for a wheelchair to turnaround. Thus, in some implementations, one or more of the first platform 210, the second platform 420, a sub-platform 430, and a portion of playground equipment 204 to which the device 201 is engaged may be at least 60-inches (152.4 centimeters) in diameter along at least a portion thereof to provide such a turnaround space. It will be understood that other sizes and shapes besides those shown and described herein are also or instead possible for the first platform 210 and other components of the system 200.

The device 201 may further include one or more barriers 240. Generally, the barriers 240 may be included for safety, e.g., to prevent users from falling off or out of certain portions of the device 201, and/or for limiting access to certain portions of the device 201. For example, one or more barriers 240 may be located adjacent to the first platform 210, where the barriers 240 are structurally configured to prevent a wheelchair from exiting the first platform 210 at least along a first direction 209 that intersects the z-axis 101 (e.g., along one or more of an x-axis and a y-axis).

Generally, and as mentioned above, one or more barriers 240 of the device 201 may include an element that protects users and/or components of the device 201. For example, barriers 240 may be structurally configured to prevent a user from falling off of the device 201 or a portion thereof. Also, or instead, a barrier 240 may be structurally configured to prevent a user from accessing certain portions of the device 201—e.g., the actuator 250, the underside of the device 201, moving components of the device 201, and so on. In this manner, a barrier 240 may be disposed on, coupled to, otherwise work in cooperation or conjunction with, and/or be structurally configured to protect one or more of the components of the device 201 such as the first platform 210, the second platform 420, and the sub-platforms 430. As shown in FIGS. 2 and 3, the barriers 240 may include one or more side barriers—e.g., a component that protects users or components of the device 201 via its sides. For example, one or more of the barriers 240 may extend from a side of one or more of the components of the device 201 such as the first platform 210. Each side of the device 201 may include barriers 240—e.g., the barriers 240 may include at least two side barriers. The barriers 240 may include one or more of a wall and a railing in some implementations. For example, certain implementations may include one or more walls surrounding (and/or extending from) portions of the device 201. These walls may be solid or substantially solid (e.g., lacking gaps larger than ⅝-inches (1.5875 centimeters) to prevent extremities of users from going through the walls). In some implementations, one or more walls are rigid, such as being made of stainless steel, plexiglass, or the like. Thus, FIGS. 2-3 generally show how barriers 240 (e.g., side barriers) may include a wall or the like (partially or wholly). That is, in certain implementations, the device 201 may include one or more walls disposed adjacent to the plurality of sub-platforms 430. These walls may be structurally configured to prevent access by certain users (e.g., children) to areas disposed beneath the plurality of sub-platforms 430. In this manner, the walls may be devoid of gaps larger than ⅝-inches (1.5875 centimeters).

In some implementations, a barrier 240 is included on, or otherwise engaged with, the first platform 210. By way of example, a barrier 240 may include a protrusion 241 disposed at the entranceway to the first platform 210. This protrusion 241 may be sized and shaped, or otherwise structurally configured, to allow a wheelchair to roll over the protrusion 241 when a predetermined amount of force is exerted on the wheelchair toward the entranceway or otherwise when the wheelchair has a predetermined inertia. In this manner, the protrusion 241 may allow a wheelchair to pass over the protrusion 241 when a user of the wheelchair has that intention, but otherwise the protrusion 241 will prevent the wheelchair and its user from inadvertently exiting or entering the first platform 210. This protrusion 241 may also or instead be movable. For example, in certain implementations, the protrusion 241 is movable between a blocking position and an unblocking position, where the blocking position prevents a wheelchair from rolling over the protrusion 241, and where the unblocking position allows a wheelchair to roll over the protrusion 241. In this manner, the protrusion 241 may be movable between a position beneath a top surface of the first platform 210 and a position above a top surface of the first platform 210.

One or more of the barriers 240 may also or instead include a movable arm, e.g., a movable arm disposed at the entranceway to the first platform 210. In certain implementations, the movable arm is lockable in a position configured to prevent access to or from the first platform 210. To this end, the movable arm may automatically lock when the first platform 210 is not in the first position, and/or when the first platform 210 (or another portion of the device 201) is moving. In certain aspects, this movable arm may include a gate 245 (e.g., a swinging gate) or the like.

As described herein, the plurality of sub-platforms 430 may be disposed between the first platform 210 and the second platform 420, or more generally, the plurality of sub-platforms 430 may be disposed between the first platform 210 and a portion of playground equipment 204 to which the device 201 is engaged or disposed adjacent to. As discussed above, when the first platform 210 is disposed in the first position, the plurality of sub-platforms 430 may define stairs between the first z-axis height 411 of the first platform 210 and the second z-axis height 421 of the second platform 420 (and/or a portion of playground equipment 204 to which the device 201 is engaged). One or more of the plurality of sub-platforms 430 (e.g., each of the plurality of sub-platforms 430) may be movable along the z-axis 103 between the stair position and a platform position, where the platform position is substantially disposed at the second z-axis height 421.

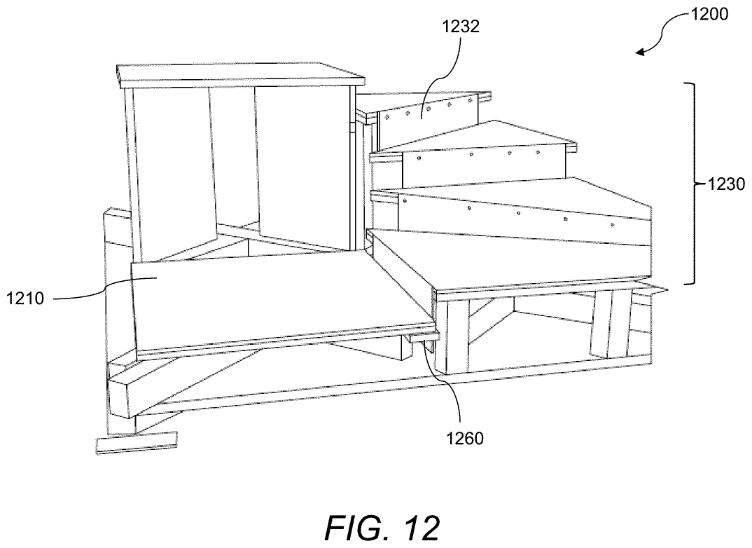

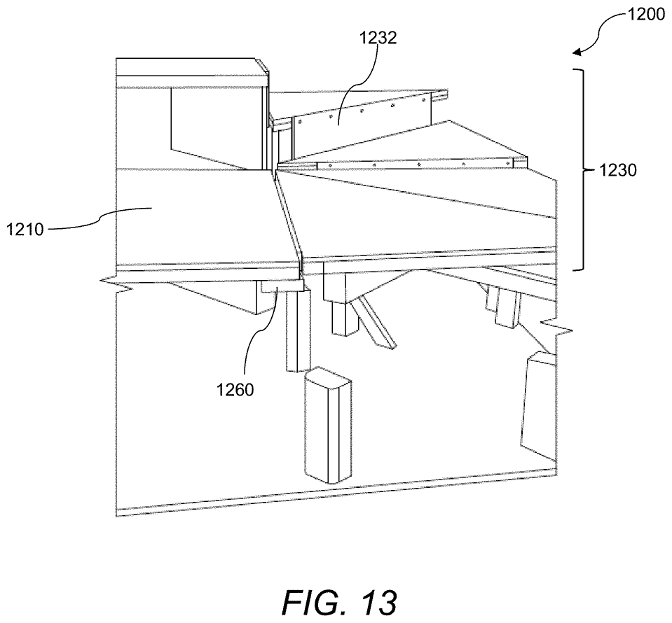

As shown in FIG. 4, stairs defined by the plurality of sub-platforms 430 in the first position may be substantially aligned along a common axis. That is, in certain implementations, stairs defined by the plurality of sub-platforms 430 in the first position may define a staircase devoid of any turns. In other implementations, stairs defined by the plurality of sub-platforms 430 in the first position are not substantially aligned along a common axis—see, e.g., FIGS. 12-13. That is, in certain implementations, stairs defined by the plurality of sub-platforms 430 in the first position may define a staircase including one or more turns. For example, stairs defined by the plurality of sub-platforms 430 in the first position may at least partially define a spiral staircase or the like. Also, or instead, one or more of the stairs defined by the plurality of sub-platforms 430 in the first position may be disposed at an angle relative to one another along one or more of an x-axis and a y-axis.

The sub-platforms 430 may come in a variety of shapes and sizes. For example, at least one sub-platform 430 of the plurality of sub-platforms 430 may be substantially rectangular. Also, or instead, at least one sub-platform 430 of the plurality of sub-platforms 430 may be substantially triangular—see, e.g., FIGS. 12-13. Other shapes are also or instead possible. Regarding size, one or more of the sub-platforms 430 may include sizes that adhere to industry standards for stairs. By way of example, one or more of the plurality of sub-platforms 430 (e.g., each of the plurality of sub-platforms 430) may be at least 8-inches (20.32 centimeters) in depth. By way of further example, one or more of the plurality of sub-platforms 430 (e.g., each of the plurality of sub-platforms 430) may be at least 48-inches (121.92 centimeters) in width. Other dimensions are also or instead possible for one or more of the sub-platforms 430.

As discussed herein, the device 201 may include a second platform 420. In general, the second platform 420 may be the component of the device 201 that couples to playground equipment 204. More specifically, the second platform 420 may be coupled to playground equipment 204 and disposed away from the first platform 210 along one or more axes (e.g., one or more of an x-axis and a y-axis). The second platform 420 may be disposed at the second z-axis height 421 as shown in FIG. 4. The second platform 420 may define a smaller area than the first platform 210 in certain implementations. For example, in certain aspects, the second platform 420 is merely a fixture structurally configured to couple the device 201 to playground equipment 204 (e.g., a frame or the like)—and, in such implementations, or other implementations, the second platform 420 may be fixed. In other implementations, the second platform 420 may be the same size, or larger, than the first platform 210.

The second platform 420 may define a top step in the stairs defined by the plurality of sub-platforms 430 in the first position. To this end, the second platform 420 may define the last of the plurality of sub-platforms 430 disposed away from the first platform 210. In this manner, the second platform 420 may be movable along the z-axis 103 in the same or similar manner to other ones of the plurality of sub-platforms 430, e.g., between a stair position and a platform position. In other implementations, the second platform 420 may be stationary or fixed—e.g., where the second platform 420 is always disposed at the second z-axis height 421. In this manner, the second platform 420 may define the structure that is structurally configured for coupling to a portion of playground equipment 204, and thus, the second platform 420 may define a portion of a frame or the like for the device 201.

The actuator 250 may be the component of the system 200 that mechanically moves one or more other components of the device 201 such as the first platform 210 and one or more of the sub-platforms 430. For example, in certain implementations, the actuator 250 is engaged with the first platform 210, and the actuator 250 is activatable to move the first platform 210 along the z-axis 103 between the first position and the second position, e.g., between the first z-axis height 411 and the second z-axis height 421. The actuator 250 may also or instead be engaged with one or more sub-platforms 430 of the plurality of sub-platforms 430.

The actuator 250 may be manual, pneumatic, hydraulic, and/or electric. For example, the device 201 may include a motor 452 coupled to the actuator 250, and/or the actuator 250 may include one or more hydraulic lifts. In this manner, a hydraulic pump may be coupled to the actuator 250. Also, or instead, the device 201 may include a power source 454 coupled to the actuator 250—e.g., one or more of photovoltaics (PV) for conversion of light into electricity, a battery, a connection to an electrical grid, a generator, a gas tank, a manual power source such as a hand crank, and the like. The actuator 250 may be in communication with a switch 456 or the like for activating the actuator 250 to move one or more components of the device 201.

Thus, in certain aspects, the actuating system may be hydraulic. In this manner, the actuator 250 may include a pump that is powered by a battery for activating one or more (e.g., two) hydraulic rams that are structurally configured to move a platform of the device. Stated otherwise, the actuator 250 may include one or more hydraulic rams (e.g., two hydraulic rams disposed on each side of the device 201) that may be driven through hydraulic tubing by a pump/motor 452 powered by a power source 454 such as a battery that can be charged by a light source such as the sun. Separate hydraulic rams may work in coordination with one another in the actuating system. For example, the hydraulic rams may move one or more of the platforms of the device 201 using a pulley system, where the pulley systems associated with each hydraulic ram are tethered to one another via cabling or the like for coordinated movement. Stated otherwise, the device 201 may include one or more hydraulic lifts tethered to a pulley system that is connected to the first platform 210 for moving the first platform 210. Other lifting mechanisms are also or instead possible.

As discussed herein, the device 201 may be structurally configured such that its components move in a coordinated manner. For example, the device 201 may be structurally configured such that there is coordinated movement of each of the plurality of sub-platforms 430 between the stair position and the platform position. This coordinated movement may include one or more of the plurality of sub-platforms 430 (e.g., each of the plurality of sub-platforms 430) moving in sequence between the stair position and the platform position. For example, when transitioning from stairs to a platform, the first platform 210 may move first, which then triggers a first sub-platform to move next, which then triggers a second sub-platform to move next, and so on. And this sequence of movement may be overlapping—e.g., where some of these components are moving simultaneously, even where they may begin moving in a staggered or sequential manner.

Because the device 201 may be specifically configured for engaging with, coupling to, or otherwise working in a cooperative manner with playground equipment, the device 201 may be designed to adhere to relatively strict standards that are placed upon playgrounds and playground equipment. To this end, the device 201 may be designed to minimize pinching, crushing, and/or shearing points. For example, in the device 201, there may be no gaps larger than ⅝-inches (1.5875 centimeters) present between the first platform 210 and the plurality of sub-platforms 430, and no gaps larger than ⅝-inches (1.5875 centimeters) present between any of the plurality of sub-platforms 430. Also, or instead, the pathway formed when the first platform 210 is elevated may lack voids larger than ⅝-inches (1.5875 centimeters) between structures defining the pathway. Further, the device 201 may include risers coupled to each of the plurality of sub-platforms 430 to minimize pinching, crushing, and/or shearing points.

As generally shown in FIGS. 2-4, the device 201 may substantially be housed in a structure 308 or other housing. That is, the device 201 may be housed in a movable structure 308 for ease in transport and/or for ease in affixing or other engaging the device to playground equipment 204. More specifically, the first platform 210, the barriers 240, the second platform 420, the plurality of sub-platforms 430, and the actuator 250 may be contained in such a movable structure 308. In this manner, the entire structure can be placed on the bed of a truck, a trailer, or the like for transport. Also, or instead, one or more of these components may be coupled together to form the movable structure 308.

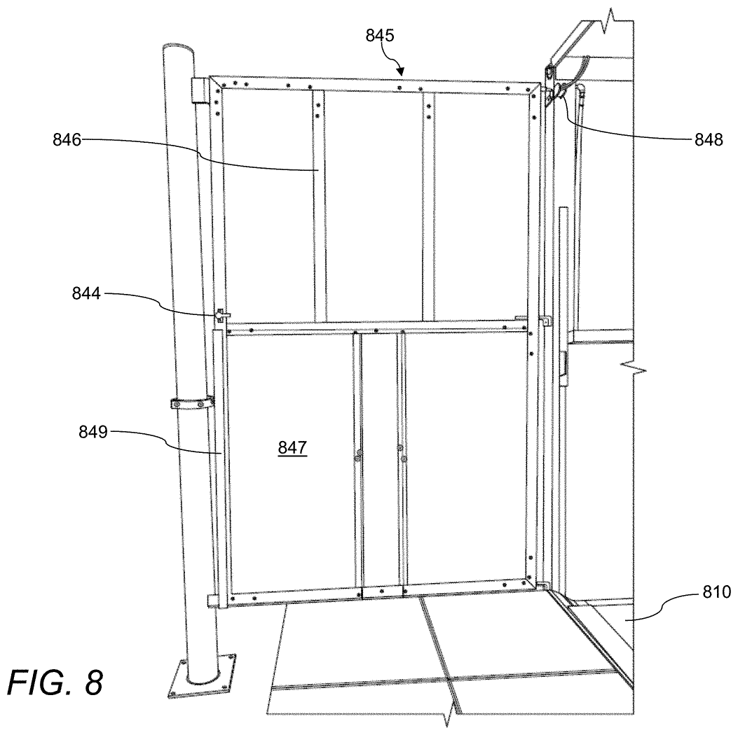

Therefore, and as generally shown in FIGS. 2-4, a system 200 according to the present teachings may include a device 201 engaged with playground equipment 204 (and, more specifically, a leading edge and/or an elevated platform of the playground equipment 204), where the device 201 is structurally configured for lifting a user (e.g., a wheelchair user) onto the playground equipment 204 as described herein. The device 201 may further include a gate 245, which may act as a barrier as described herein for securing a user onto a first platform 210 of the device 201 and/or for preventing access to an area beneath the first platform 210, e.g., when the first platform 210 is moving or is in an elevated position. The gate 245 may be secured to an anchor point such as a post 246 or the like as shown in the figures, e.g., when the gate 245 is in an open position. When in a closed position, the gate 245 may be secured to another portion of the device 201 for securing the gate 245 in the closed position. This may be accomplished via a latch, a catch, a lock, or the like, or a more robust mechanically locking arrangement, which can be especially helpful for locking the gate 245 when the first platform 210 is moving and/or is disposed in an elevated position (e.g., as described in more detail below with reference to FIGS. 8-10).

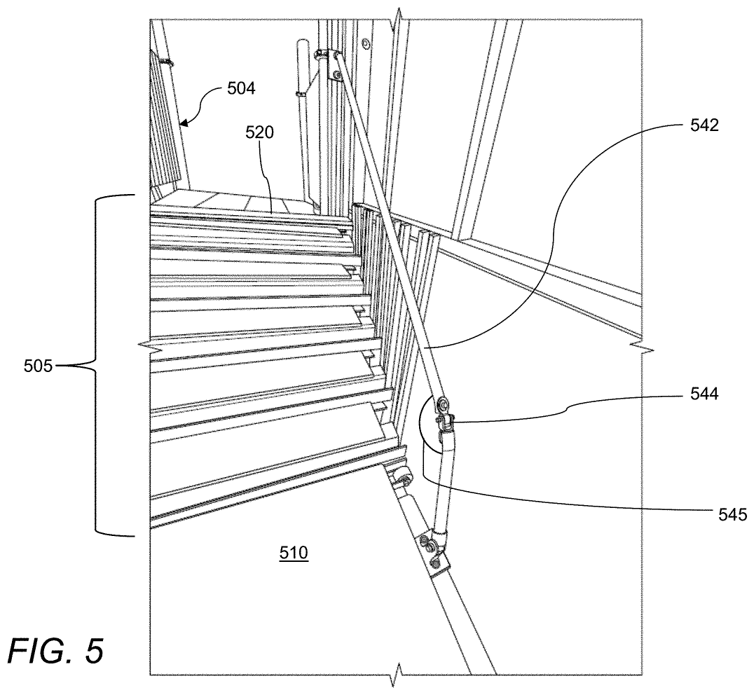

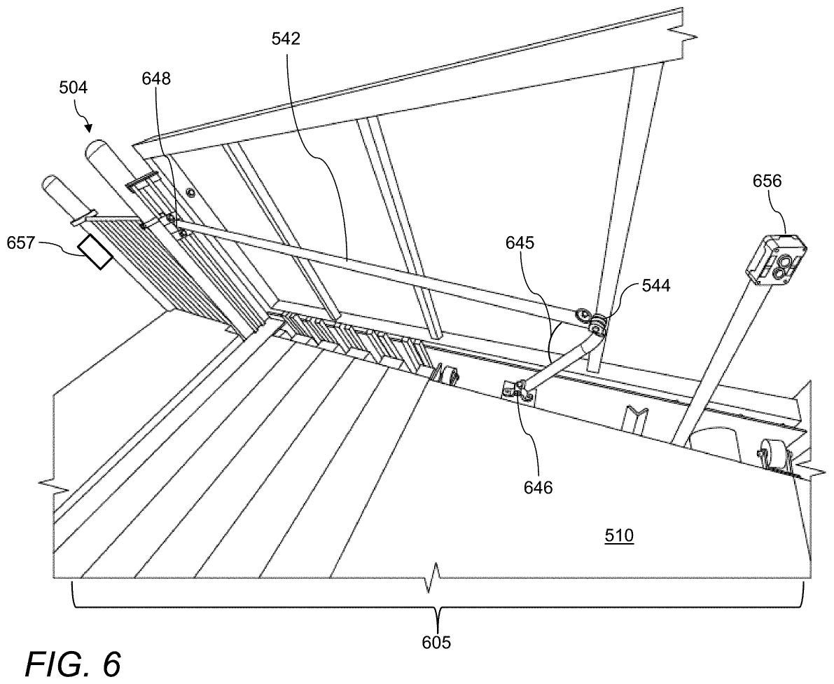

FIGS. 5 and 6 show a railing 542 for a system and device for lifting a person onto playground equipment 504, which may be any one of the systems and devices described above or otherwise herein (e.g., it may be the same system 200 shown and described above with reference to FIGS. 2-4). Specifically, FIG. 5 illustrates a railing 542 of a device for lifting a person onto playground equipment 504 when the device is in a stair position, and FIG. 6 illustrates a railing 542 of a device for lifting a person onto playground equipment when the device is in a platform position, in accordance with a representative embodiment.

The railing 542 may include a joint 544 that is structurally configured to permit the railing 542 to articulate between a stair position as shown in FIG. 5 (where the railing 542 acts as a banister or the like) and a platform position as shown in FIG. 6 where the railing 542 can still be utilized (e.g., as a handrail or the like disposed above and along an elevated platform 605). That is, the joint 544 may be structurally configured such that, when the device is in the stair position as shown in FIG. 5, the railing 542 is disposed at a first angle 545, and, when the device is in the platform position as shown in FIG. 6, the railing 542 is disposed at a second angle 645, where the first angle 545 is larger than the second angle 645 (e.g., the first angle 545 may be obtuse, and the second angle 645 may be acute). In certain implementations, when the device is in the stair position as shown in FIG. 5, the railing 542 may be disposed substantially along the same angle as the slope of the stairs (as measured from the first platform 510 to the second platform 520); and, when the device is in the platform position as shown in FIG. 6, the railing 542 may be disposed substantially along the same angle as the slope of the elevated platform 605 (which may be substantially flat—i.e., about 0 degrees or 180 degrees). And to enable such movement, the railing 542 may include a plurality of joints—e.g., including the joint 544 described directly above, a second joint 646, and a third joint 648. In such configurations, the joint 544 described directly above may be formed between different sections of the railing 542, the second joint 646 may be formed between the railing 542 and the first platform 510 (or another portion of the device, such as a first sub-platform), and the third joint 648 may be formed between the railing 542 and a portion on an elevated section of the system (e.g., coupled to the playground equipment 104, a barrier as described herein, a structural component of the device, and so on).

Thus, the railing 542 may move (e.g., pivot and raise) with the platforms of the device for lifting a person onto playground equipment 504. In this manner, the railing 542 may be specifically tailored for use on a movable platform/stair system, where stairs 505 can raise to form an elevated platform 605, and where the railing 542 can serve a function in each of these positions and use cases. Although only one railing 542 is shown, more are possible—e.g., where each side of the device includes a railing 542. Thus, the railing 542 may be disposed on one or more sides of the platforms of the device.

As described herein, and as shown in FIG. 6, the system or device may also include one or more switches. For example, the switches may include a first switch 656 and a second switch 657. The first switch 656 may be structurally configured to activate the actuator for moving the first platform 510. In certain implementations, the first switch 656 may be disposed on or adjacent to the first platform 510—in this manner, someone situated on the first platform 510 can activate the device to move between a stair and platform position. The first switch 656 may also or instead be disposed elsewhere. The second switch 657 may also or instead be structurally configured to activate the actuator for moving the first platform 510, where the second switch 657 is disposed in a different location than the first switch 656. For example, and as shown in the figure, the second switch 657 may be located on the playground equipment 504 or otherwise on an elevated portion of the system. Thus, the device may include or otherwise be in communication with a second switch 657 that is located on a portion of the device or playground equipment 504 that is accessible when the device is in an elevated, platform position. In this manner, if a first user at the unelevated level needs to access the device when it is in an elevated position, another user at the elevated position may lower the platforms of the device for the first user to access. Further, in this manner, someone situated on an elevated portion of the system could activate the actuator using the second switch 657 to raise the device to its platform position if the device is in the stair position (e.g., if the user cannot manage stairs and needs to utilize the movable first platform 510 to return to a non-elevated height). The second switch 657 may also or instead be disposed elsewhere. For example, the second switch 657 (or an additional switch, such as a third switch) may be accessible external to the device. To this end, the second switch 3757 (or another switch) may also or instead be located at the unelevated (e.g., ground) level.

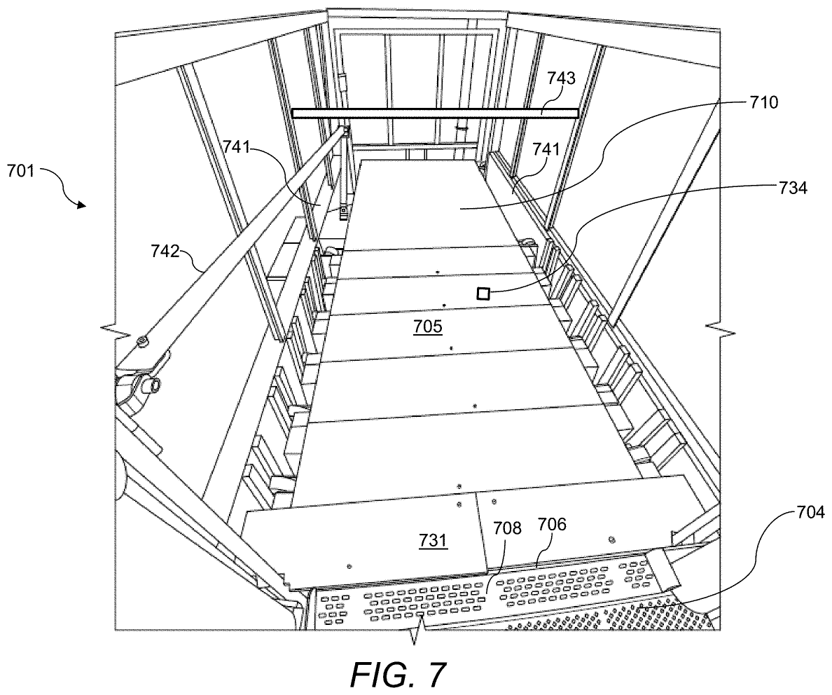

FIG. 7 illustrates a device coupled to playground equipment when the device is in a platform position, in accordance with a representative embodiment. The device 701 shown in FIG. 7 may be the same or similar to any one of the systems and devices described above or otherwise herein, but with the device 701 in the platform position. That is, in this figure, the first platform 710 and the plurality of sub-platforms may be disposed at the same height as playground equipment 704 (e.g., at the second z-axis height described above). Thus, a substantially planar pathway in the form of an elevated platform 705 is shown in FIG. 7. For example, the view in FIG. 7 may be an alternative view to what is shown and described above with reference to FIG. 6. In this manner, the figure shows an elevated platform 705 and a railing 742, where the device 701 for lifting a person onto playground equipment 704 is coupled to the playground equipment 704.

As described herein, and as shown in the figure, the device 701 may include one or more barriers structurally configured to prevent a wheelchair (or more generally, a person or object) from exiting the first platform 710. By way of example, one or more of the barriers may include a side barrier 741 disposed adjacent to the first platform 710—e.g., the side barrier 741 may extend from a side of the first platform 710. In certain implementations, multiple side barriers 741 are included on the device 701 (such as the two side barriers 741 shown in FIG. 7)—e.g., on each of the sides of the first platform 710. The side barriers 741, and more generally any of the barriers described herein, may include a wall. Also or instead, the side barriers 741 may include a rail or railing—e.g., the railing 742 can be thought of as a side barrier 741 or a portion thereof. One or more of the barriers may also or instead include a movable arm, or other movable components as described in more detail below.

For example, as shown in the figure, a system including the device 701 may have a second barrier 743 that prevents access to a portion of the device 701—e.g., prevents a user from accessing the elevated platform 705 right before (or during) movement to the stair position. In this manner, the second barrier 743 may be structurally configured to keep a user on the first platform 710 during movement between the stair position and the platform position. To this end, the second barrier 743 may be structurally configured to automatically lock upon activation of the device 701 for movement. The second barrier 743 may be movable to allow passage when conditions are determined to be safe (e.g., when the device is not moving). To this end, the device 701 may also or instead include a platform sensor 734 (e.g., a force sensor, an optical sensor, or the like) on one or more of the sub-platforms that prevents activation of the device 701 when an external force is detected. In this manner, if a user or other object is disposed on the sub-platforms when the device 701 is attempted to be activated for movement—a potentially dangerous condition—the platforms may be prevented from such movement. Thus, in certain implementations, only when the sub-platforms are clear may the device 701 be successfully activated for movement. Stated otherwise, the platform sensor 734 may be in communication with the actuator such that the actuator cannot be activated when the presence of the object is detected on the elevated platform 705.

FIG. 7 also shows engagement between the device 701 and the playground equipment 704. As discussed herein, the device 701 may be structurally configured for engagement with at least a leading edge 706 of the engagement area 708 of the playground equipment 704. This can involve a mechanical coupling between the playground equipment 704 (e.g., the leading edge 706 thereof) and a portion of the device 701 such as one or more of a frame, a barrier, the top step 731 of the sub-platforms (where this top step 731 may be movable with the sub-platforms or fixed), and so on. This can also or instead involve simply placing the device 701 substantially flush against the leading edge 706 of the playground equipment 704, and securing the device 701 in place, e.g., on the ground or to another portion of the playground equipment. Many coupling configurations are possible, although it may always be desirable to omit gaps in such coupling configurations for safety. To this end, one or more pinch preventers or the like may be utilized as described herein.

FIG. 8 illustrates a gate of a device for lifting a person onto playground equipment, in accordance with a representative embodiment. The gate 845 may include one or more barrier-like elements that are structurally configured to contain a user on a platform of the device for lifting the user onto playground equipment. Such barrier-like elements may include bars 846, blocking surfaces 847 (e.g., plexiglass or plastic surfaces, metal surfaces, screens, and the like), and so on. For example, the barrier-like elements may include an entire surface covering of a lower portion of the gate 845 so as to prevent a user from sticking a portion of their body through the gate 845 where it could be sheared or crushed by movement of the first platform 810. In this manner, the gate 845 can be thought of as a barrier as described herein, and more particularly, as the movable arm for accessing the first platform 810.

The device may further include a gate sensor 848 that is used to detect a position of the gate 845. For example, the gate sensor 848 may be structurally configured to detect when the gate 845 is in an open position (as shown in the figure) and a closed position. In certain implementations, the gate sensor 848 may be in communication (e.g., electrically coupled) with an actuating system of the device (the actuator as described herein), where the capability for actuating the device (e.g., moving the device from the first position to the second position as described herein) may not be permitted unless the gate sensor 848 detects that the gate 845 is in the closed position, which can be an advantageous safety feature for the device. In one example, the gate sensor 848 may interrupt a circuit of the actuating system when the gate 845 is open (e.g., not allowing current to pass between a power source and a motor/pump), and the gate sensor 848 may complete a circuit of the actuating system when the gate 845 is closed (e.g., thereby allowing current to pass between a power source and a motor/pump). In this manner, the gate sensor 848 may include a contact sensor or contact switch, where contact between different portions of the sensor allows for operation of the device. Other sensors that communicate with an actuating system for permitting selective activation thereof may also or instead be used. For example, the gate sensor 848 may also or instead include one or more of an optical sensor, a proximity sensor, a capacitive sensor, a flex sensor, an impact sensor, a photoelectric sensor, a piezoelectric sensor, a position sensor, an infrared sensor, a light sensor, a pressure sensor, a force sensor, and so on.

In some implementations, while the gate sensor 848 (or another component) may restrict the use or function of an actuating system to lift a platform of the device under certain conditions, the gate sensor 848 (or another component) may have no effect on the ability of platforms of the device to lower if and when desired (e.g., subject to other safety precautions such as a user disposed in an incorrect or improper position on an elevated platform—for example, being disposed on the sub-platforms). By way of example, an actuating system of the device may be a hydraulic system that does not require power (e.g., electricity) to lower, for example, due to gravity or other pressure/force conditions. That is, by simply triggering the opening of a valve in the hydraulic system, hydraulic fluid may be released from hydraulic rams that thereby lowers the platforms of the device. Stated otherwise, the actuator may be hydraulic, where the actuator does not require power to safely lower the first platform from the second position to the first position and each of the plurality of sub-platforms from the platform position to the stair position. To this end, such a hydraulic system may include flow control devices (e.g., flow restrictors) that permit only a predetermined flow of hydraulic fluid when lowering (or raising) the platforms between an elevated position and a non-elevated position (e.g., a platform position and a stair position). In other words, a controlled release of hydraulic fluid may provide controlled, predetermined movement of the platforms of the device. In this manner, the speed that the platforms move may be mechanically controlled—e.g., preventing a drastically quick fall from an elevated position to a non-elevated position. Other control devices may also or instead be used to control the speed of movement of the platforms of the device.

The gate 845 may include a latch 844 for securing the gate 845 to the body of the device in a releasable manner.

As described in more detail below, the gate 845 may also or instead include a platform engagement portion 849 disposed thereon. The platform engagement portion 849 may be structurally configured to engage with a portion of the first platform 810 (e.g., a gate engagement portion described below) when the gate 845 is closed as an added security feature. More particularly, the platform engagement portion 849 may be structurally configured to engage with a portion of the first platform 810 during movement of the first platform 810 such that, during such movement and/or when the first platform 810 is in an elevated position, this engagement prevents the gate 845 from opening. In some implementations, the platform engagement portion 849 includes a channel (e.g., a C-channel) or slot, where the gate engagement portion traverses within this channel or slot when elevated or moving, thereby securing the gate 845 to the first platform 810 such that the platform engagement portion 849 mechanically locks the gate 845 in the closed position during such movement.

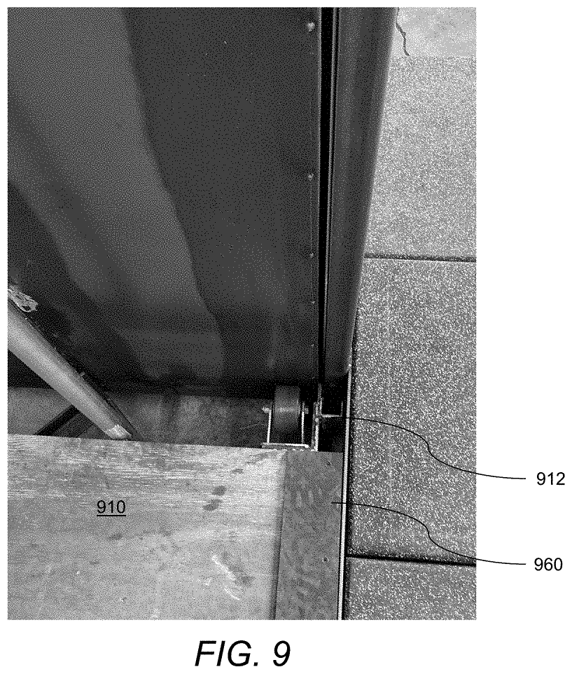

FIG. 9 illustrates a gate engagement portion 912 of a first platform of a device for lifting a person onto playground equipment, in accordance with a representative embodiment. The gate engagement portion 912 may be structurally configured for engagement with a platform engagement portion such as that described directly above. In this manner, the platform engagement portion and the gate engagement portion 912 may be structurally configured to cooperate with one another when using the device for lifting a user onto playground equipment. In general, the platform engagement portion and the gate engagement portion 912 may be structurally configured to engage one another in a manner that retains or locks a position of the gate when the gate is closed and the first platform 910 is moving or is otherwise disposed in an elevated position above the first position.

For example, and as explained above, the platform engagement portion disposed on the gate may include a slot or the like for receiving a protrusion or the like of the gate engagement portion 912 disposed on the first platform 910. In this manner, the protrusion of the gate engagement portion 912, when positioned in the slot of the platform engagement portion, may prevent the gate from swinging open, which can be an advantageous safety feature for preventing a user from falling off of the first platform 910 when it is elevated or moving. Other configurations of the platform engagement portion and the gate engagement portion 912 may be provided in addition to or instead of the aforementioned sample embodiment, for example including other mechanical keying or cooperating components. Other elements, such as magnets or the like may also or instead be used. Regardless, it may be desirous or advantageous to retain the gate in a closed position when the first platform 910 is elevated or moving.

This figure further shows a pinch preventer 960, which may be structurally configured to mitigate pinching or shearing of elements (e.g., a user's fingers) between components or pieces of the device for lifting a person onto playground equipment. The pinch preventer 960 may include a flexible material (such as a strip of rubber or the like) disposed on or between one or more portions (e.g., all portions) of the device that move relative to one another. Thus, a device as described herein may include a pinch preventer 760 disposed between one or more portions of the device having a gap.

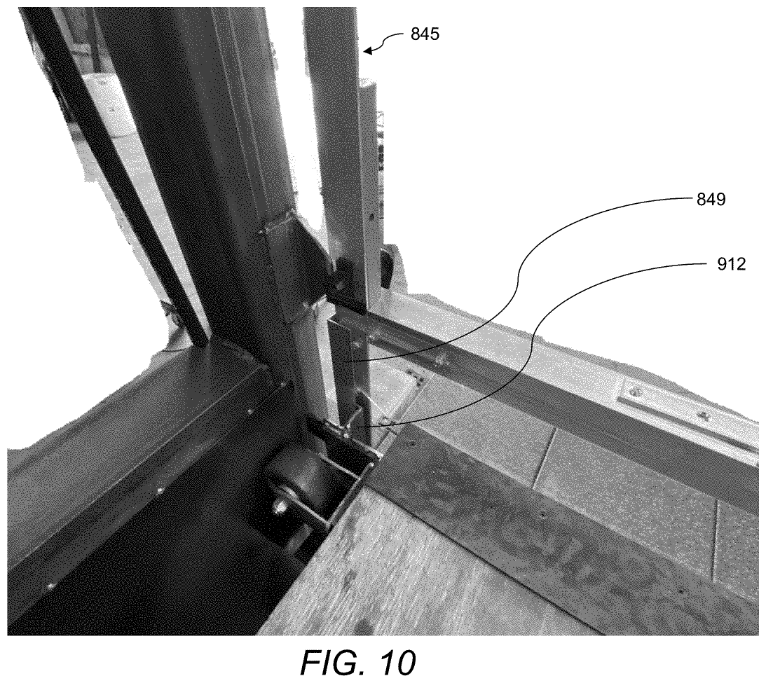

FIG. 10 illustrates the platform engagement portion 849 of the gate 845 engaged with a gate engagement portion 912 of a device for lifting a person onto playground equipment, in accordance with a representative embodiment. As shown in this figure, when engaged, the platform engagement portion 849 and the gate engagement portion 912 can prevent opening of the gate 845. The device may be structurally configured so that, in the first position where the first platform is lowered, the platform engagement portion 849 and the gate engagement portion 912 are not engaged with one another, such that the gate 845 can be opened.

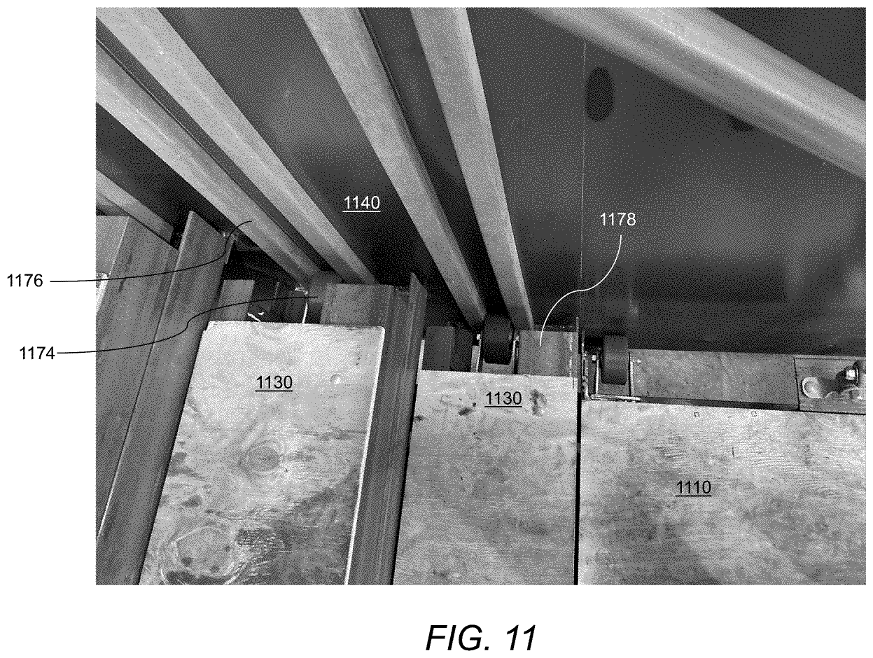

FIG. 11 illustrates rollers and guides of a device for lifting a person onto playground equipment, in accordance with a representative embodiment. Specifically, as shown in this figure, one or more of the platforms (e.g., the first platform 1110 and one or more of the sub-platforms 1130) may include or otherwise be in communication with one or more rollers 1174 (e.g., wheels such as caster wheels or the like). The rollers 1174 may facilitate relatively smooth motion of the platforms, and may be used in conjunction with (or may be part of) guides 1176 or a guiding system for movement of the platforms. In certain implementations, the guides 1176 include one or more of a track and a rail. It will be understood that, although the guides 1176 are shown as protruding out from a structure of the device, the guides 1176 may also or instead include indentions within the structure. It will further be understood that the rollers 1174 may be supplemented with, or replaced by, bearings or the like. Other configurations are also or instead possible, including at least one of a wheel, a bearing, a slider, and a glide.

Thus, in certain implementations, the device may include one or more guides 1176 disposed adjacent to at least one sub-platform 1130 of a plurality of sub-platforms 1130. A guide 1176 may facilitate predetermined movement of a sub-platform 1130 between the stair position and the platform position (e.g., along the z-axis), and/or may prevent other movement of the sub-platform 1130 when moving between the stair position and the platform position. Also or instead, the guides 1176 may facilitate predetermined movement of the first platform 1110 between the first position and the second position, and may prevent other movement of the first platform 1110 when moving between the first position and the second position. In this manner, a guide 1176 may include a protrusion engaged with at least one sub-platform 1130 of the plurality of sub-platforms 1130 (e.g., a roller 1174 thereof).

The device may further include one or more stops 1178 disposed below at least one sub-platform 1130 of the plurality of sub-platforms 1130. The stop 1178 may be positioned to prevent z-axis movement below the stair position for a sub-platform 1130. For example, the device may include a stop 1178 for each sub-platform 1130. In certain implementations, the device includes at least two stops 1178 for each sub-platform 1130, where the stops 1178 are disposed on opposite sides of each sub-platform 1130 along a wall 1140 or the like.

Thus, the device may include one or more walls 1140 disposed adjacent to the plurality of sub-platforms 1130. The walls 1140 may be structurally configured to prevent access by certain users to areas disposed beneath the plurality of sub-platforms 1130. In certain implementations, the walls 1140 are devoid of gaps larger than ⅝-inches (1.5875 centimeters).

As described above, the device may include one or more guides 1176 disposed adjacent to at least one sub-platform 1130 of the plurality of sub-platforms 1130, where a guide 1176 may be structurally configured to facilitate predetermined movement of a sub-platform 1130 between the stair position and the platform position. This predetermined movement may be substantially along the z-axis. Further, a guide 1176 may be structurally configured to prevent other movement of the sub-platform 1130 when moving between the stair position and the platform position. Thus, the guides 1176 may be structurally configured to facilitate up-and-down movement of one or more of the components of the device, while preventing other, undesired movement such as movement along an x-axis or y-axis. A guide 1176 may include one or more of a track and a rail; also, or instead, the guide 1176 may include, or may be structurally configured to work in conjunction with, a protrusion engaged with at least one sub-platform 1130 of the plurality of sub-platforms 1130, where the protrusion is structurally configured to cooperate with one or more of the track and the rail. For example, one or more of the guides 1176 or the protrusion may include at least one of a wheel, a bearing, a slider, and a glide. Also, or instead, guides 1176 may be used to facilitate desired movement of other components of the device. For example, in certain implementations, the device includes one or more guides 1176 disposed adjacent to the first platform 1110, where a guide 1176 is structurally configured to facilitate predetermined movement of the first platform 1110 between the first position and the second position and to prevent other movement of the first platform 1110 when moving between the first position and the second position. Again, this predetermined movement may be substantially along the z-axis.

FIG. 12 illustrates a device 1200 for lifting a person onto playground equipment, and FIG. 13 illustrates the device 1200 for lifting a person onto playground equipment, where the device 1200 is transitioning from a stair position to a platform position, in accordance with a representative embodiment. The device 1200 shown in these figures may be similar to those described above, but where stairs defined by the plurality of sub-platforms 1230 in the first position (see FIG. 12) are not substantially aligned along a common axis. Rather, each of the stairs defined by the plurality of sub-platforms 1230 in the first position are disposed at an angle relative to one another to form a staircase having one or more turns. In this manner, the stairs defined by the plurality of sub-platforms 1230 in the first position may at least partially define a spiral staircase. Also, or instead, each of the stairs defined by the plurality of sub-platforms 1230 in the first position may be disposed at an angle relative to one another along one or more of the x-axis and the y-axis. When arranged in a configuration with a turn, a central structure such as a post, and/or peripheral structures such as posts around a circumference of the platforms, may be configured such that the platforms may be guided along such structures via guides or the like (similar to those described elsewhere herein) that are structurally configured to facilitate predetermined movement of the platforms, e.g., between the stair position and the elevated, platform position.

Further, FIGS. 12 and 13 demonstrate an example of a coupler 1260 that can link one or more of the movable components of the device 1200. Specifically, in this example, the coupler 1260 may link the first platform 1210 to one or more of the sub-platforms 1230 (e.g., the first sub-platform, which may itself include a similar coupler 1260 to engage with a subsequent sub-platform). In this manner, the coupler 1260 may act as a “catch” that connects components of the device 1200 when they are moved into a coordinated position.

The stairs defined by the plurality of sub-platforms 1230 in the first position (i.e., the stair position) may come in many different sizes and shapes. For example, as shown in these figures, at least one sub-platform 1230 may be substantially triangular. Alternatively, and consistent with various figures described above, at least one sub-platform 1230 may be substantially rectangular, or substantially square. Other shapes are also or instead possible, including other polygons and non-polygons. In certain implementations, each of the plurality of sub-platforms 1230 may be at least 8-inches (20.32 centimeters) in depth. And, in certain implementations, each of the plurality of sub-platforms 1230 may be at least 48-inches (121.92 centimeters) in width.

The platforms of the device 1200, and the device 1200 more generally, may be structurally configured to minimize pinching, crushing, and shearing points. To this end, the device 1200 may include risers 1232 coupled to each of the plurality of sub-platforms 1230 to aid in minimizing such pinching, crushing, and shearing points. Also or instead, the device 1200 may lack voids larger than ⅝-inches (1.5875 centimeters) between structures thereof.

Further, FIGS. 12 and 13 demonstrate how the sub-platforms 1230 may move in sequence, where their movement may be coordinated with movement of the first platform 1210.

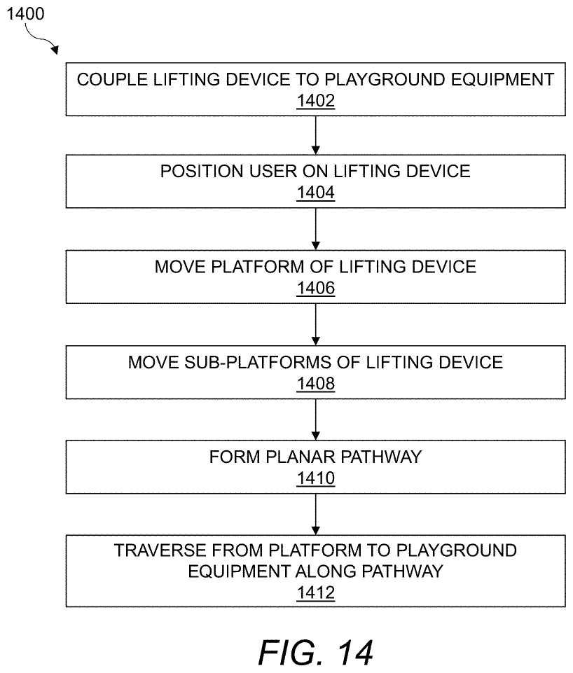

FIG. 14 is a flow chart of a method for providing accessibility to playground equipment for users with disabilities, in accordance with a representative embodiment. The method 1400 may be implemented using any of the devices and systems described herein.

As shown in step 1402, the method 1400 may include coupling a lifting device to an engagement area of playground equipment. The engagement area of playground equipment may simply include an elevated platform or the like.

As shown in step 1404, the method 1400 may include positioning a user on the lifting device. This may include positioning a user on a first platform of the lifting device disposed at a first z-axis height. The first platform may be disposed adjacent to a plurality of sub-platforms, where the plurality of sub-platforms are disposed between the first platform and the engagement area of the playground equipment. The engagement area may have a substantially planar surface disposed at a second z-axis height that is greater than the first z-axis height. The plurality of sub-platforms may define stairs between the first z-axis height of the first platform and the second z-axis height of the substantially planar surface.

As shown in step 1406, the method 1400 may include moving a platform of the lifting device. More specifically, this may include moving, via an actuator, the first platform along a z-axis from the first z-axis height to the second z-axis height.

As shown in step 1408, the method 1400 may include moving, via one or more of the actuator and movement of the first platform, each of the plurality of sub-platforms along the z-axis from a stair position to the second z-axis height.

As shown in step 1410, the method 1400 may include forming a substantially planar pathway at the second z-axis height between the first platform and the playground equipment.

As shown in step 1412, the method 1400 may include traversing from the first platform to the playground equipment via the pathway.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings.

Unless the context clearly requires otherwise, throughout the description, the words “comprise,” “comprising,” “include,” “including,” and the like are to be construed in an inclusive sense as opposed to an exclusive or exhaustive sense; that is to say, in a sense of “including, but not limited to.” Additionally, the words “herein,” “hereunder,” “above,” “below,” and words of similar import refer to this application as a whole and not to any particular portions of this application.

It will be appreciated that the devices, systems, and methods described above are set forth by way of example and not of limitation. For example, regarding the methods provided above, absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A system for accessible playground equipment, the system comprising:
playground equipment including an engagement area at an elevated height above grade; and
a lifting device structurally configured for engagement with at least a leading edge of the engagement area of the playground equipment, the lifting device comprising:
a first platform movable along a z-axis between a first position at a first z-axis height and a second position at a second z-axis height, the second z-axis height substantially equal to the elevated height of the engagement area;
a plurality of sub-platforms disposed between the first platform and the engagement area, wherein, when the first platform is disposed in the first position, the plurality of sub-platforms define stairs to traverse between the first z-axis height of the first platform and the second z-axis height of the engagement area, and wherein the plurality of sub-platforms are movable along the z-axis between a stair position and a platform position, the platform position substantially disposed at the second z-axis height;
an actuator engaged with the first platform, the actuator activatable to move the first platform along the z-axis between the first position and the second position; and
one or more couplers connecting the first platform and one or more sub-platforms of the plurality of sub-platforms such that movement of the first platform via the actuator between the first position and the second position provides coordinated movement of each of the plurality of sub-platforms between the stair position and the platform position,
wherein, when the first platform is in the second position and each of the plurality of sub-platforms is in the platform position, a pathway is formed between the first platform and the engagement area of the playground equipment, the pathway substantially planar.

2. The system of claim 1, further comprising a power source coupled to the actuator, wherein the power source includes photovoltaics for conversion of light into electricity.

3. The system of claim 1, wherein the actuator includes one or more hydraulic lifts.

4. The system of claim 1, wherein the actuator is hydraulic, and wherein the actuator does not require power to lower the first platform from the second position to the first position and each of the plurality of sub-platforms from the platform position to the stair position.

5. The system of claim 1, further comprising a railing that is movable with one or more of the sub-platforms between the stair position where the railing functions as a banister and the platform position where the railing functions as a handrail disposed above the pathway.

6. The system of claim 1, further comprising:
a gate that is movable between an open position and a closed position; and
a gate sensor structurally configured to detect when the gate is in the closed position, the gate sensor in communication with the actuator such that the actuator is prevented from lifting the first platform when the gate is in the open position.

7. The system of claim 6, further comprising a platform engagement portion disposed on the gate and a gate engagement portion disposed on the first platform, the platform engagement portion and the gate engagement portion couplable with one another during movement of the first platform, wherein coupling of the platform engagement portion and the gate engagement portion during movement of the first platform mechanically locks the gate in the closed position.

8. The system of claim 1, wherein a first coupler of the one or more couplers connects the first platform and a first sub-platform of the plurality of sub-platforms, and wherein a second coupler of the one or more couplers connects the first sub-platform to another sub-platform of the plurality of sub-platforms.

9. The system of claim 1, wherein the stairs defined by the plurality of sub-platforms in the first position are substantially aligned along a common axis.

10. The system of claim 1, wherein the stairs defined by the plurality of sub-platforms in the first position are not substantially aligned along a common axis.

11. A device for lifting a person onto playground equipment to provide accessibility for users with disabilities, the device comprising:
a first platform accessible to a wheelchair via an entranceway, the first platform movable along a z-axis between a first position at a first z-axis height and a second position at a second z-axis height;
one or more barriers adjacent to the first platform, the one or more barriers structurally configured to prevent the wheelchair from exiting the first platform at least along a first direction intersecting the z-axis;
a second platform coupled to playground equipment and disposed away from the first platform along one or more of an x-axis and a y-axis, the second platform disposed at the second z-axis height;
a plurality of sub-platforms disposed between the first platform and the second platform, wherein, when the first platform is disposed in the first position, the plurality of sub-platforms define stairs between the first z-axis height of the first platform and the second z-axis height of the second platform, and wherein each of the plurality of sub-platforms is movable along the z-axis between a stair position and a platform position, the platform position substantially disposed at the second z-axis height;
an actuator engaged with the first platform, the actuator activatable to move the first platform along the z-axis between the first position and the second position; and
one or more couplers connecting the first platform and one or more sub-platforms of the plurality of sub-platforms such that movement of the first platform via the actuator between the first position and the second position provides coordinated movement of each of the plurality of sub-platforms between the stair position and the platform position,
wherein, when the first platform is in the second position and each of the plurality of sub-platforms is in the platform position, a pathway is formed between the first platform and the playground equipment, the pathway being substantially planar.

12. The device of claim 11, wherein no gaps larger than ⅝-inches (1.5875 centimeters) are present between the first platform and the plurality of sub-platforms, and wherein no gaps larger than ⅝-inches (1.5875 centimeters) are present between any of the plurality of sub-platforms.

13. The device of claim 11, further comprising risers coupled to each of the plurality of sub-platforms to minimize pinching, crushing, and shearing points.

14. The device of claim 11, wherein the actuator is hydraulic, and wherein the actuator does not require power to lower the first platform from the second position to the first position and each of the plurality of sub-platforms from the platform position to the stair position.

15. The device of claim 11, wherein the coordinated movement of each of the plurality of sub-platforms between the stair position and the platform position includes each of the plurality of sub-platforms moving in sequence between the stair position and the platform position.

16. The device of claim 11, wherein the first platform, the one or more barriers, the second platform, the plurality of sub-platforms, and the actuator are contained in movable structure.

17. The device of claim 11, further comprising a railing that is movable with one or more of the sub-platforms between the stair position where the railing functions as a banister and the platform position where the railing functions as a handrail disposed above the pathway.

18. The device of claim 11, further comprising:
a gate that is movable between an open position and a closed position; and
a gate sensor structurally configured to detect when the gate is in the closed position, the gate sensor in communication with the actuator such that the actuator is prevented from lifting the first platform when the gate is in the open position.

19. The device of claim 18, further comprising a platform engagement portion disposed on the gate and a gate engagement portion disposed on the first platform, the platform engagement portion and the gate engagement portion couplable with one another during movement of the first platform, wherein coupling of the platform engagement portion and the gate engagement portion during movement of the first platform mechanically locks the gate in the closed position.

20. A method for providing accessibility to playground equipment for users with disabilities, the method comprising:
coupling a lifting device to an engagement area of playground equipment;
positioning a user on a first platform of the lifting device disposed at a first z-axis height, the first platform disposed adjacent to a plurality of sub-platforms, wherein the plurality of sub-platforms are disposed between the first platform and the engagement area, the engagement area disposed at a second z-axis height greater than the first z-axis height, the plurality of sub-platforms defining stairs between the first z-axis height of the first platform and the second z-axis height of the engagement area;
moving, via an actuator, the first platform along a z-axis from the first z-axis height to the second z-axis height; and
moving, via one or more of the actuator and movement of the first platform, one or more of the plurality of sub-platforms along the z-axis from a stair position to the second z-axis height thereby forming a substantially planar pathway at the second z-axis height between the first platform and the playground equipment.
